(19) United States
(12) Patent Application Publication
(10) Pub. No.: US 2005/0060272 A1
(43) Pub. Date: Mar. 17, 2005

(54) Embedded system program code reduction method and system

(76) Inventor: Wen-Hua Lin, Taipei (TW)

Correspondence Address: FULBRIGHT AND JAWORSKI L L P;PATENT DOCKETING 29TH FLOOR, 865 SOUTH FIGUEROA STREET, LOS ANGELES, CA, 900172576, US

(21) Appl. No.: 10/660,029

(22) Filed: Sep. 11, 2003

(51) Int. Cl. G06F 15/18

(52) U.S. Cl. 706/12

(57) ABSTRACT

An embedded system program code reduction method and system is proposed, which is designed for use to scale down the total amount of program code that is to be burned into an embedded system for the purpose of reducing the embedded system's memory requirement and thereby increasing the embedded system's performance. The proposed method and system is characterized by that the program code loaded into the embedded system only includes bytecode-based application programs (rather than source code based application programs), those essential objects that are required by these application programs during runtime, and the runtime environment from the virtual machine, while excluding the complier of the virtual machine. This feature allows the embedded system to have a reduced memory requirement and a higher system performance.

### BACKGROUND OF THE INVENTION

1. Field of the Invention

This invention relates to information technology, and more particularly, to an embedded system program code reduction method and system, which is used for scaling down the total amount of program code that is to be burned into an embedded system for the purpose of reducing the embedded system's memory requirement and also allowing the embedded system to be increased in performance. The program code that is to be scaled down includes a virtual machine, such as Java Virtual Machine (JVM) or Microsoft Virtual Machine (MVM), and a set of application programs running on the virtual machine.

2. Description of Related Art

Portable information platforms, such as mobile phones, PDAs, pagers, etc., are typically based on an embedded controller that integrates a microprocessor and a set of system and application programs in the same device. Presently, a virtual machine, such as Java Virtual Machine (JVM) or Microsoft Virtual Machine (MVM) is integrated to the embedded system as a cross-platform foundation for the running of application programs on the information platform. The use of virtual machine allows application programs to have the so-called “write once, run everywhere” capability that allows one version of an application program to run on different types of information platforms installed with different kinds of operating systems. This feature allows software programmers to write just one version of an application program of a specific function, and the application program can then run on different types of information platforms installed with different kinds of operating systems, without having to write many different versions of applications programs for the same functionality.

FIG. 1 is a schematic diagram showing the architecture of a virtual machine 20 (such as JVM) and a set of application programs (for example 3 application programs 31, 32, 33) that are to be burned together with an operating system 40 to an embedded system 10 built in a portable information platform 11, such as a mobile phone. The virtual machine 20 includes an object library 21, a complier 22, and a runtime environment 23. In the case of the virtual machine 20 being a JVM, for example, its object library 21 includes a “lang” package 21a for language-related functions, a “util” package 21b for various utilities, an “io” package 21c for input-output related functions, an “awt” package 21d for graphic interface related functions, an “awt.image” package 21e for advanced graphic interfaces, a “net” package 21f for network-related functions, an “applet” package 21g for HTML related functions, and various other packages 21h for other functions.

Since JVM and MVM are well-known virtual machines in the information industry, and the JVM's components are also well known, detailed description thereof will not be given here in this specification.

Traditionally, all the application programs 31, 32, 33 are loaded in the form of source code into the embedded system 10 and all the components of the virtual machine 20, including the whole object library 21, the complier 22, and the runtime environment 23, are all loaded together with the operating system 40 into the embedded system 10. During actual operation, the embedded system 10 executes the application programs 31, 32, 33 in such a manner that it will first use the complier 22 to compile the application programs 31, 32, 33 into bytecode, and then fetches from the object library 21 all the objects that are required by the application programs 31, 32, 33 during runtime, and finally use the runtime environment 23 to support the running of the bytecode to thereby provide the intended functions of the application programs 31, 32, 33.

The foregoing practice is suitable for use in general-purpose computing platforms. However, since the embedded system 10 is typically designed to provide a set of specialized functions from the application programs 31, 32, 33, it only needs a very small portion of the object library 21, and therefore it would be quite memory-wasteful to load all the packages 21a, 21b, 21c, 21d, 21e, 21f, 21g, and 21h of the object library 21 entirely into the embedded system 10. The traditional practice would therefore degrade the system performance of the information platform 11.

One solution to the foregoing problem is to increase the capacity of memory in the embedded system 10. One drawback to this solution, however, is that it would require additional cost to install the additional memory and therefore is quite cost-ineffective. Moreover, unnecessary objects and components will still loaded into the embedded system 10 and occupy a significant portion of the memory that would nevertheless degrade the system performance of the information platform 11.

Another solution to the foregoing problem is to abandon the virtual machine 20 and compile the application programs 31, 32, 33 directly into the machine code that can be directly executed by the microprocessor of the embedded system 10. One drawback to this solution, however, is that it would lose the write-once-run-everywhere capability for the application programs 31, 32, 33 to run on different types of information platforms installed with different kinds of operating systems, and therefore would require the software programmers to write many different versions of applications programs for the same functionality, which is undoubtedly an even more cost-ineffective practice.

### SUMMARY OF THE INVENTION

It is therefore an objective of this invention to provide an embedded system program code reduction method and system that can scale down the total amount of program code that is to be loaded into an embedded system, including a virtual machine and a set of application programs running on the virtual machine, so as to help reduce the embedded system's memory requirement.

It is another objective of this invention to provide an embedded system program code reduction method and system that can help increase the performance of an embedded system.

The embedded system program code reduction method and system according to the invention is designed for use to scale down the total amount of program code that is to be burned into an embedded system for the purpose of reducing the embedded system's memory requirement and also allowing the embedded system to be increased in performance. The program code that is to be scaled down includes a virtual machine, such as Java Virtual Machine (JVM) or Microsoft Virtual Machine (MVM), and a set of application programs running on the virtual machine.

The embedded system program code reduction method and system according to the invention is characterized by that the program code loaded into the embedded system only includes bytecode-based application programs (rather than source code based application programs as in the case of the prior art), those essential objects that are required by these application programs during runtime, and the runtime environment from the virtual machine, while excluding the complier of the virtual machine. This feature can help reduce the total amount of program code that is to be burned in the embedded system, and therefore allows the embedded system to have a reduced memory requirement and a higher system performance.

### BRIEF DESCRIPTION OF DRAWINGS

The invention can be more fully understood by reading the following detailed description of the preferred embodiments, with reference made to the accompanying drawings, wherein:

FIG. 1 (PRIOR ART) is a schematic diagram showing the architecture of a virtual machine and a set of application programs that are loaded in an embedded system on a portable information platform;

FIG. 2 is a schematic diagram showing an object-oriented component model of the embedded system program code reduction system according to the invention; and

FIG. 3 is a schematic diagram used to depict the operation of an object picking module to pick required objects from JVM's object library.

### DETAILED DESCRIPTION OF PREFERRED EMBODIMENTS

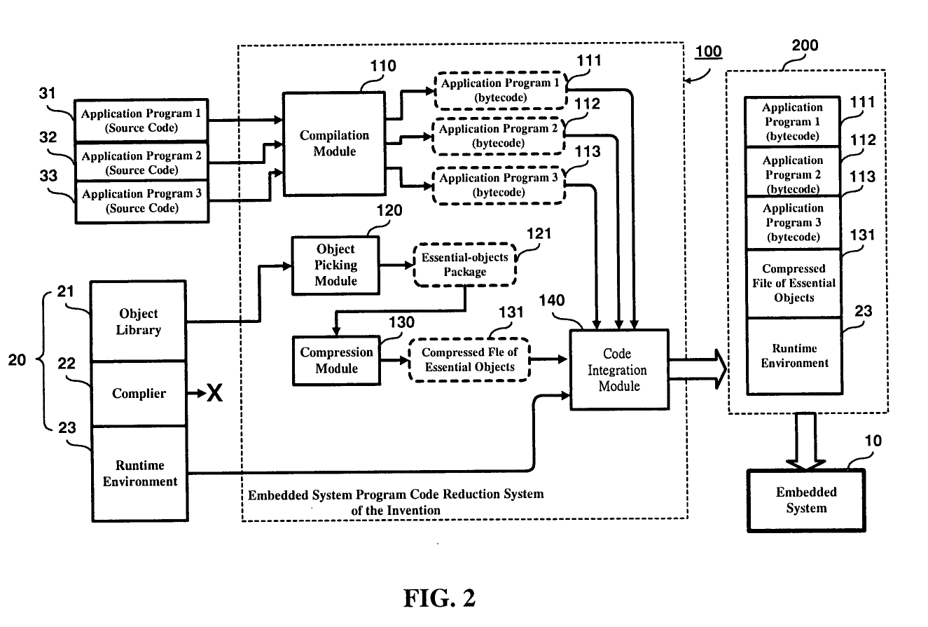

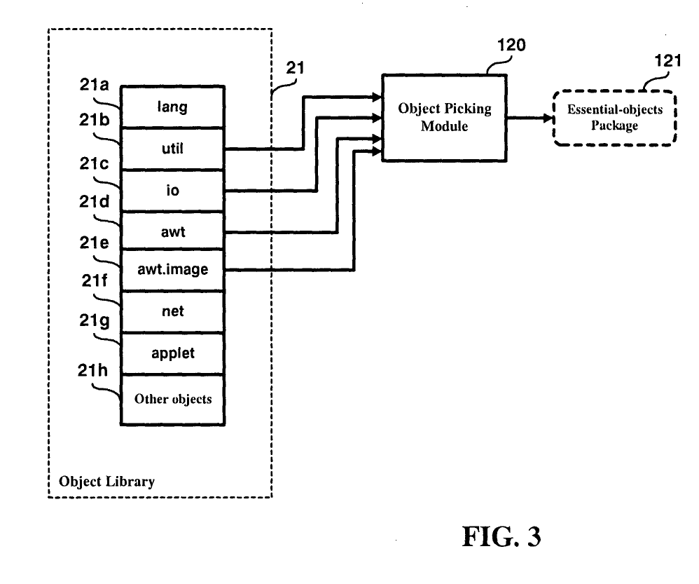

The embedded system program code reduction method and system according to the invention is disclosed in full details by way of preferred embodiments in the following with reference to FIG. 2 and FIG. 3.

FIG. 2 is a schematic diagram showing an object-oriented component model of the embedded system program code reduction system of the invention (as the part enclosed in the dotted box indicated by the reference numeral 100). As shown, the embedded system program code reduction system of the invention 100 is designed to scale down a virtual machine 20 and a set of application programs running on the virtual machine 20 (for example 3 application programs 31, 32, 33, but any number of application programs is feasible) that are to be burned into an embedded system 10, with the purpose of reducing the embedded system's memory requirement and also allowing the embedded system 10 to be increased in performance.

The virtual machine 20 is, for example, a Java Virtual Machine (JVM) or a Microsoft Virtual Machine (MVM), which includes an object library 21, a complier 22, and a runtime environment 23. Since JVM and MVM are well-known virtual machines in the information industry, detailed description thereof will not be given here in this specification.

The object-oriented component model of the embedded system program code reduction system of the invention 100 comprises: (a) a compilation module 110; (b) an object picking module 120; (c) a compression module 130; and (d) a code integration module 140.

The compilation module 110 is functionally the same as the complier 22 in the virtual machine 20, which is used to compile the source code of each of the application programs 31, 32, 33 into bytecode (hereinafter referred to as “bytecode-based application programs” 111, 112, 113)

The object picking module 120 is used to pick out from the object library 21 all the essential objects that are required for use by the application programs 31, 32, 33 during runtime and collectively pack all the picked objects into an essential-objects package 121. As shown in FIG. 3, taking JVM as example, the JVM's object library includes a “lang” package 21a for language-related functions, a “util” package 21b for various utilities, an “io” package 21c for input-output related functions, an “awt” package 21d for graphic interface related functions, an “awt.image” package 21e for advanced graphic interfaces, a “net” package 21f for network-related functions, an “applet” package 21g for HTML related functions, and various other packages 21h. Traditionally, all of these packages 21a, 21b, 21c, 21d, 21e, 21f, 21g, and 21h are entirely burned into the embedded system 10. By contrast, the invention utilizes the object picking module 120 to pick out just those essential objects from the object library 21 that are absolutely required for use by the application programs 31, 32, 33 during runtime. All unnecessary objects are unpicked. For example, assume the application program 31 only use the “util” package 21b, the “io” package 21c, the “awt” package 21d, and the “awt.image” package 21e in the object library 21, and use none of the other packages 21a, 21f, 21g, 21h. In this case, the object picking module 120 will operate based on user's specified options to pick out the required objects from those packages 21b, 21c, 21d, 21e in the object library 21, and the collectively pack all the picked objects into an essential-objects package 121.

The compression module 130 is used to compress the essential-objects package 121 from the object picking module 120 into a compressed file of essential objects 131. The compression method used by the compression module 130 can be any kind of non-destructive compression method.

The code integration module 140 is used to integrate the binary code of all the bytecode-based application programs 111, 112, 113, the binary code of the compressed file of essential objects 131, and the binary code of the runtime environment 23 into a set of embedded system program code 200 which is to be burned into the embedded system 10.

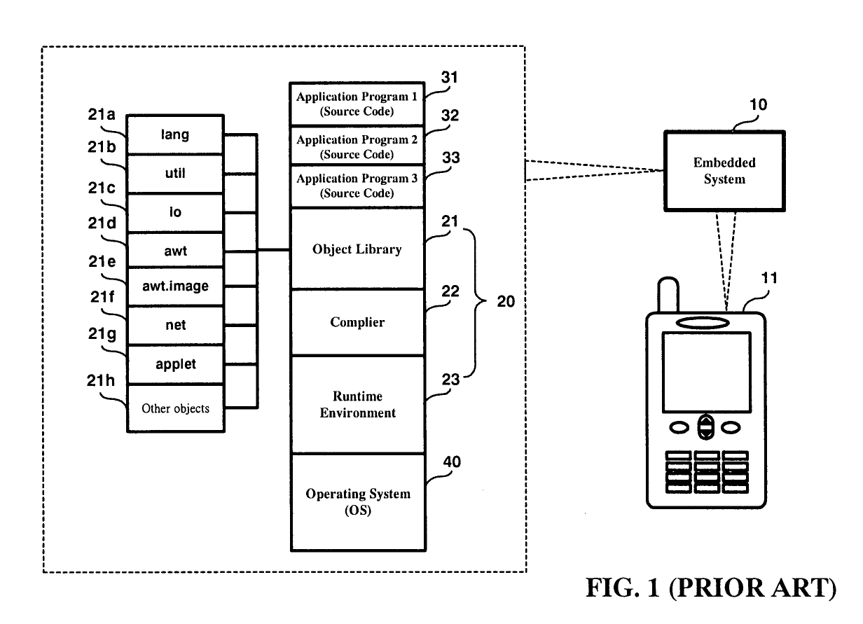

Compared to the prior art of FIG. 1, since the embedded system program code reduction system of the invention 100 produces a down-scaled set of set of embedded system program code 200 which is distinguishable from the prior art by the inclusion of bytecode-based application programs 111, 112, 113 (rather than source code based application programs in the case of the prior art), the inclusion of a compressed file of essential objects 131 (rather than the entire uncompressed object library 21 in the case of the prior art), and the exclusion of the complier 22. This feature can help reduce the total amount of program code that is to be burned in the embedded system, and therefore allows the embedded system 10 to have a reduced memory requirement and provide an increased level of system performance.

In conclusion, the invention provides an embedded system program code reduction method and system, which is characterized by that the program code loaded into the embedded system only includes bytecode-based application programs (rather than source code based application programs as in the case of the prior art), those essential objects that are required by these application programs during runtime, and the runtime environment from the virtual machine, while excluding the complier of the virtual machine. This feature can help reduce the total amount of program code that is to be burned in the embedded system, and therefore allows the embedded system to have a reduced memory requirement and a higher system performance.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

1. An embedded system program code reduction method for scaling down a virtual machine and a set of application programs running on the virtual machine that are to be burned into an embedded system, wherein the virtual machine includes an object library, a complier, and a runtime environment;
the embedded system program code reduction method comprising:
a compilation procedure for compiling the source code of each application program into bytecode;
an object picking procedure for picking those essential objects that are required for use by the application programs during runtime and collectively pack all picked objects into an essential-objects package;
a compression procedure for compressing the essential-objects package into a compressed file of essential objects; and
a code integration procedure for integrating each bytecode-based application program, the compressed file of essential objects from the compression module, and the runtime environment from the virtual machine into a set of embedded system program code which is to be burned into the embedded system.

2. The embedded system program code reduction method of claim 1, wherein the virtual machine is a Java Virtual Machine.

3. The embedded system program code reduction method of claim 1, wherein the virtual machine is a Microsoft Virtual Machine.

4. An embedded system program code reduction system for use to scale down a virtual machine and a set of application programs running on the virtual machine that are to be burned into an embedded system, wherein the virtual machine includes an object library, a complier, and a runtime environment;
the embedded system program code reduction system comprising:
a compilation module, which is used to compile the source code of each application program into bytecode;
an object picking module, which is used to pick those essential objects that are required for use by the application programs during runtime and collectively pack all picked objects into an essential-objects package;
a compression module, which is used to compress the essential-objects package into a compressed file of essential objects; and
a code integration module, which is used to integrate each bytecode-based application program, the compressed file of essential objects from the compression module, and the runtime environment from the virtual machine into a set of embedded system program code which is to be burned into the embedded system.

5. The embedded system program code reduction system of claim 4, wherein the virtual machine is a Java Virtual Machine.

6. The embedded system program code reduction system of claim 4, wherein the virtual machine is a Microsoft Virtual Machine.
